(19) United States
(12) Patent Application Publication
(10) Pub. No.: US 2026/0308412 A1
(43) Pub. Date: Oct. 8, 2026

(54) COATING COMPOSITION FOR A SENSOR COVER AND A SENSOR COVER

(71) Applicants: HYUNDAI MOTOR COMPANY, Seoul (KR); KIA CORPORATION, Seoul (KR)

(72) Inventors: Seon-Yong An, Hwaseong-si (KR); Kyoung-Chun Kweon, Hwaseong-si (KR); Sae-Ah Kim, Hwaseong-si (KR); Jang Kyung Kim, Siheung-si (KR); Hun Sung Ha, Siheung-si (KR); Chi Won Kim, Siheung-si (KR); Wan-Ho Son, Gunpo-si (KR); Gyeom-Son Seong, Gunpo-si (KR)

(73) Assignees: HYUNDAI MOTOR COMPANY, Seoul (KR); KIA CORPORATION, Seoul (KR)

(21) Appl. No.: 19/261,658

(22) Filed: Jul. 7, 2025

(30) Foreign Application Priority Data
Apr. 8, 2025 (KR) 10-2025-0045303

(51) Int. Cl. C09D 175/04; G01S 7/481; G01S 17/931

(52) U.S. Cl. CPC C09D 175/04; G01S 17/931; G01S 7/4813

(57) ABSTRACT

A coating composition for a sensor cover is disclosed. The coating composition includes a polyaspartic resin and an acrylic polyol resin, wherein the polyaspartic resin and the acrylic polyol resin are mixed in a ratio in a range of 99:1-80:20. Further, a sensor cover is disclosed. The sensor cover includes a base layer and a protective layer coated on the base layer. A coating composition is formed on the protective layer including a first polyaspartic resin and a second polyaspartic resin, and an acrylic resin. The first polyaspartic resin, the second polyaspartic resin, and the acrylic resin are mixed in a ration is a range of 99:1-80:20.

### CROSS-REFERENCE TO RELATED APPLICATION

This application claims priority to Korean Patent Application No. 10-2025-0045303, filed on Apr. 8, 2025, which is incorporated herein by reference in its entirety.

### BACKGROUND OF THE DISCLOSURE

### Field of the Disclosure

An embodiment of the present disclosure relates to a coating composition forming a coating layer of a transparent cover applied to a sensor and a sensor cover.

### Description of Related Art

As the importance of autonomous driving has increased, a light detection and ranging (LiDAR) unit for detecting obstacles and the like near a vehicle has been installed on vehicles.

A LiDAR detects objects based on light reflected from objects by emitting infrared light.

Covers for a LiDAR sensor have mainly focused on a simple protection function, and these covers are mainly made of plastic, glass, or other materials.

The LiDAR sensor is mainly located at the front and upper sides of a vehicle, and in addition to the LiDAR sensor, sensors exposed to the outside of the vehicle are inevitably susceptible to damage by external factors.

Furthermore, damage to the cover can result in a decrease in the sensing performance of the sensor, which becomes an even more important issue in autonomous driving.

Accordingly, the sensor cover may be coated with a protective layer for protecting the cover, and self-restoration of the protective layer against external damage generally takes 2 to 24 hours at room temperature.

Matters described above in the background art are intended to help in understanding of the background of the disclosure and may include matters not related to the related art already known to those having ordinary skill in the art to which this technology pertains.

### SUMMARY OF THE DISCLOSURE

An embodiment of the present disclosure has been made in efforts to solve the above problems and is directed to providing a coating composition for a sensor cover, which is a coating composition for protecting a sensor cover and has a more improved self-restoration function than conventional coating agents for a sensor cover, and a sensor cover.

A coating composition for a sensor cover according to an embodiment of the present disclosure includes a polyaspartic resin and an acrylic polyol resin, wherein the polyaspartic resin and the acrylic polyol resin are mixed in a ratio of 99:1 to 60:40.

The polyaspartic resin includes a first polyaspartic resin and a second polyaspartic resin.

In addition, the first polyaspartic resin and the second polyaspartic resin are mixed in a ratio of 9:1 to 7:3.

Specifically, the first polyaspartic resin includes an amine value (mg KOH/g) of 196 to 204 and a molecular weight (Mw) of 500 to 600, and the second polyaspartic resin includes an amine value (mg KOH/g) of 188 to 196 and a molecular weight (Mw) of 600 to 700.

In addition, the acrylic polyol resin includes a hydroxyl group (—OH group) of 110 to 120 and a molecular weight (Mw) of 8,000 to 10,000.

Furthermore, an isocyanate curing agent is mixed in an amount of 50 to 150 wt % based on 100 wt % of the polyaspartic resin.

An embodiment includes a first isocyanate hardener and a second isocyanate hardener, and the first isocyanate hardener and the second isocyanate hardener may be mixed in a ratio of 1:9 to 5:5.

In a coating composition for a sensor cover according to an embodiment of the present disclosure, the first polyaspartic resin and the second polyaspartic resin are mixed in a ratio of 9:1 to 7:3.

The first polyaspartic resin includes an amine value (mg KOH/g) of 196 to 204 and a molecular weight (Mw) of 500 to 600, and the second polyaspartic resin includes an amine value (mg KOH/g) of 188 to 196 and a molecular weight (Mw) of 600 to 700.

In addition, the coating composition further includes an acrylic polyol resin, wherein the acrylic polyol resin includes a hydroxyl group (—OH group) of 110 to 120 and a molecular weight (Mw) of 8,000 to 10,000.

Furthermore, an isocyanate curing agent is mixed in an amount of 50 to 150 wt % based on 100 wt % of the polyaspartic resin, and the first isocyanate resin and the second isocyanate resin are mixed in a ratio of 1:9 to 5:5.

A sensor cover according to an embodiment of the present disclosure includes a base layer, and a protective layer coated on the base layer, wherein a coating composition forming the protective layer includes a first polyaspartic resin and a second polyaspartic resin, and an acrylic polyol resin, and the first polyaspartic resin, the second polyaspartic resin, and the acrylic polyol resin are mixed in a ratio of 99:1 to 60:40.

The first polyaspartic resin and the second polyaspartic resin are mixed in a ratio of 9:1 to 7:3.

In addition, the first polyaspartic resin includes an amine value (mg KOH/g) of 196 to 204 and a molecular weight (Mw) of 500 to 600, and the second polyaspartic resin includes an amine value (mg KOH/g) of 188 to 196 and a molecular weight (Mw) of 600 to 700.

In addition, the acrylic polyol resin includes a hydroxyl group (—OH group) of 110 to 120 and a molecular weight (Mw) of 8,000 to 10,000.

Furthermore, an isocyanate curing agent is mixed in an amount of 50 to 150 wt % based on 100 wt % of the first polyaspartic resin and the second polyaspartic resin.

According to the coating composition of an embodiment of the present disclosure, it is possible to implement the coating agent that has the excellent self-restoration performance compared to conventional coating agents and has a desired hardness and self-restoration performance by having the adjustable self-restoration time and curing speed.

It can be seen through the chipping resistance test and the pencil hardness test that the self-restoring time is faster than that of existing coating agents.

### BRIEF DESCRIPTION OF THE DRAWINGS

FIG. 1 schematically illustrates a sensor cover.

FIG. 2 is a reaction mechanism of a conventional coating composition.

FIG. 3 is a reaction mechanism of a coating composition of an embodiment of the present disclosure.

FIG. 4 is an example of a scratch resistance test of a conventional coating layer, and FIG. 5 is an example of a scratch resistance test of a coating layer of an embodiment of the present disclosure.

FIG. 6 is a state before a chipping resistance test of a conventional coating layer, and FIG. 7 is a state after the chipping resistance test of the conventional coating layer.

FIG. 8 is a state before a chipping resistance test of a coating layer of an embodiment of the present disclosure, and FIG. 9 is a state after the chipping resistance test of the coating layer of an embodiment of the present disclosure.

FIG. 10 is a state before a pencil hardness test of the conventional coating layer, and FIGS. 11 and 12 are states after the pencil hardness test of the conventional coating layer.

FIG. 13 is a state before a pencil hardness test of the coating layer of an embodiment of the present disclosure, and FIGS. 14 and 15 are states after the pencil hardness test of the coating layer of an embodiment of the present disclosure.

### DETAILED DESCRIPTION

For a full understanding of the present disclosure, operational advantages of the present disclosure, and objects to be achieved by practicing the present disclosure, reference should be made to the accompanying drawings, which illustrate example embodiments of the present disclosure, and contents described in the accompanying drawings.

In describing the example embodiments of the present disclosure, a description of known techniques or repetitive descriptions that may unnecessarily obscure the gist of the present disclosure have been reduced or omitted.

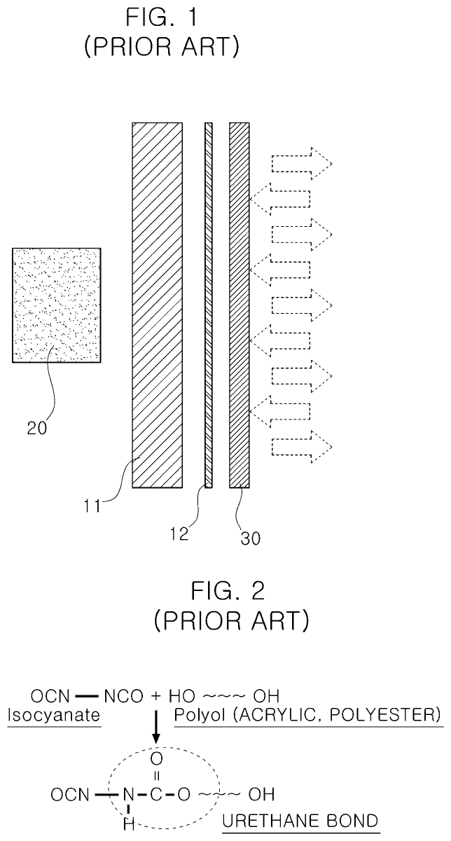

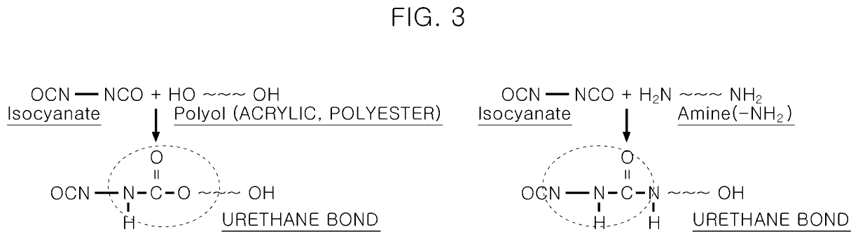

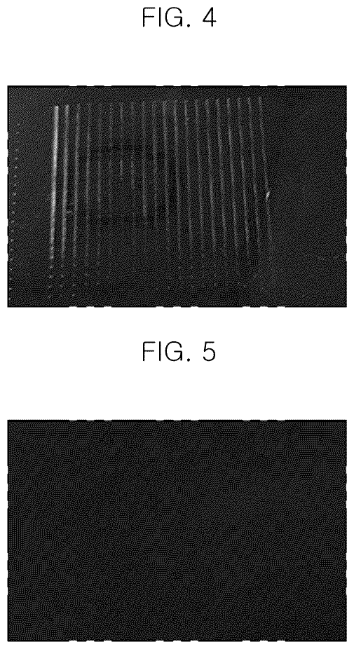

FIG. 1 schematically illustrates a sensor cover. In addition, FIG. 2 is a reaction mechanism of a conventional coating composition, and FIG. 3 is a reaction mechanism of a coating composition of an embodiment of the present disclosure.

Hereinafter, a coating composition for a sensor cover and a sensor cover according to an embodiment of the present disclosure are described with reference to FIGS. 1-3.

The coating composition of an embodiment of the present disclosure is a composition for a protective layer coated on a sensor cover and may be applied to a sensor cover mounted on a vehicle in addition to a light detection and ranging (LiDAR) sensor.

As shown in FIG. 1, a protective layer 30 may be coated on a base layer 11, such as glass, PC (Polycarbonate), and the like, which transmits light from a sensor 20, and a film layer 12 for transparency, low reflection, a design pattern, or a color may be interposed on the base layer 11.

Self-restoration of external damage to a conventional protective layer takes 2 to 24 hours at room temperature, and a scratch test method is performed by scratching 100 mm of a surface of a sample article or a test sample manufactured under conditions equivalent to the sample article with a load of 9.8 N (Newton) at a speed of 100 mm/s and then observing the surface state after 2 hours according to JIS (Japanese Industrial Standards) K 6718.

In contrast, an embodiment of the present disclosure intends to confirm self-restoration performance using the Erichsen scratch tester method, which is a harsher condition than the conventional test method, and aims to achieve self-restoration within 1 minute with high hardness and elasticity.

This is a very important part for autonomous driving sensors (LiDAR) that are always running (especially since, when a scratch occurs, sensing performance decreases by about 30 to 50%).

A resin composition of the related art for a protective layer is mainly formed of polyester polyol, polycarbonate polyol, and acrylic polyol, and thus requires a slow curing speed, post-drying, and an organometallic catalyst.

As shown in FIG. 2, the resin composition has a single polyurethane reaction mechanism in which polyol and isocyanate are combined.

An embodiment of the present disclosure, however, is formed of a polyurethane composition that combines polyaspartic (upper-level name: polyester) and polyol, thereby enabling a fast and controllable curing speed.

In addition, the post-drying process is unnecessary, or a very short time is sufficient, and the organometallic catalyst is necessary in trace amounts or is unnecessary.

As shown in FIG. 3, the sensor composition of an embodiment of the present disclosure has two reaction mechanisms as a thermosetting polyurethane.

The polyurethane reaction is formed by bonding a polyol and an isocyanate, and the polyurea reaction is formed by bonding a polyaspartic resin and an isocyanate as follows.

Hydroxy group (—OH)+Isocyanate, —NCO→forms a urethane bond (—NHCOO—).

Amine group (—NH)+Isocyanate, —NCO→forms a urea bond (—NHCONH—).

A configuration of the polyurethane composition, which is the coating composition of an embodiment of the present disclosure, includes a polyaspartic resin, an acrylic polyol, and an isocyanate-based curing agent.

In addition, the configuration of the polyurethane composition may include two types of polyaspartic resins (e.g., a first polyaspartic resin and a second polyaspartic resin).

The first polyaspartic resin has a solid content of 100%, an amine value (mg KOH/g) in a range of 196 to 204, and molecular weight (Mw) in a range of 500 to 600, and its characteristics are fast hardness formation, high weather resistance, and room temperature drying.

The second polyaspartic resin has a solid content of 100%, an amine value (mg KOH/g) in a range of 188 to 196, and molecular weight (Mw) in a range of 600 to 700, and its characteristics are long working life, high weather resistance, and an excellent exterior.

When the first polyaspartic resin and the second polyaspartic resin are mixed in an appropriate ratio (9:1 to 7:3), the working life and curing speed may be controlled, and an excellent exterior may be formed.

Since the first polyaspartic resin has a fast working life and poor exterior gloss, and the second polyaspartic resin has a slow working life and excellent exterior gloss, an optimal ratio of the first polyaspartic resin and the second polyaspartic resin is selected. Upon exceeding this range, the working time is too fast or slow, resulting in poor workability and exterior.

An acrylic polyol resin has a solid content of 60%, a hydroxyl group (—OH group) of 110 to 120 (solid), a Tg (glass transition temperature) of 2 degrees, and a molecular weight (Mw) of 8,000 to 10,000.

The acrylic polyol resin includes excellent adhesion, flexibility, scratch recovery, and self-healing functions.

The polyaspartic resin and the acrylic polyol resin are formed of 99:1 to 60:40.

This enables excellent adhesion, flexibility, scratch recovery, and self-healing functions, and the acrylic polyol resin shortens the curing speed and supplements the above physical properties.

When the acrylic polyol resin is less than 1%, adhesion is reduced, and when exceeding 20%, the curing time is delayed.

Isocyanate A may have a solid content of 100%, isocyanate group (NCO) in a range of 23 to 24%, and an equivalent weight aliphatic HDI trimer (isocyanurate) of 177 to 181 (eq).

The isocyanate A is widely used in vehicle refinishing industrial coating agents because it is non-yellowing and has excellent weather resistance, hardness, and mechanical properties.

Isocyanate B may have a solid content of 90%, NCO of 8 to 9%, and an equivalent weight aliphatic HDI trimer (adduct) of 492 to 496 (eq).

The isocyanate B is non-yellowing, has excellent weather resistance, and provides elasticity functionality without adding plasticizer. In addition, the self-restoration performance is improved as the content of the isocyanate B increases.

The two curing agents can provide desired hardness and elasticity functions at an appropriate ratio.

For example, a ratio of aliphatic polyisocyanate A and hexamethylene diisocyanate B with elasticity characteristics ranges from 1:9 to 5:5, and the desired hardness and elasticity may be adjusted within the corresponding range.

In addition, self-restoration and a curing speed may be adjusted.

For hard segment adjustment, when the isocyanate A is abundant, self-restoration is very slow due to change in hardness, and when the isocyanate B is abundant, scratch recovery is fast due to change in softness, but physical properties are poor.

An ultraviolet absorber, a light stabilizer, a leveling agent, and a defoamer may be further included, and the ultraviolet absorber is included to prevent yellowing and discoloration due to light resistance.

The ultraviolet absorber may be included in an amount of 0.1 to 2 wt % based on 100 wt % of the polyaspartic and acrylic polyol mixture, which is the main components of polyurethane.

The type of the ultraviolet absorber is a triazine-based material, and a chemical composition thereof may be a mixture of 2-[4-[(2-Hydroxy-3-dodecyloxypropyl)oxy]-2-hydroxyphenyl]-4,6-bis(2,4-dimethylphenyl)-1,3,5-triazine and 2-[4-[(2-Hydroxy-3-tridecyloxypropyl)oxy]-2-hydroxyl phenyl]-4,6-bis(2,4-dimethylphenyl)-1,3,5-triazine.

The light stabilizer is a hindered amine light stabilizer (HALS), and the chemical composition thereof can be a mixture of Bis-(1-octyloxy-2,2,6,6-tetramethyl-4-piperidinyl) sebacate.

The ultraviolet absorber may be included in an amount of 0.1 to 2 wt % based on 100 wt % of polyaspartic and polyol, which are the main components of polyurethane.

In addition, when the ultraviolet absorber and the light stabilizer exceed 6 wt %, the mechanical properties of an embodiment of the present disclosure can deteriorate.

Leveling agent A is a polyether-modified polydimethylsiloxane as a main component and improves material wettability, prevents crater phenomenon, and provides surface slippage.

General properties are a density (20° C.) of 0.93 g/mol, a solid content (30 mm, 150° C.) of 12.5%, solvent xylene/monophenyl glycol=7/2, and a flash point of 25° C.

The leveling agent A may be included in an amount of 1 to 3 wt % based on 100 wt % of a mixture of polyaspartic and acrylic polyol, which are the main components of polyurethane.

Leveling agent B is a silicone-modified polyacrylate with OH functional groups as its main component and may be included in the crosslinking of polymers through a hydroxyl group reaction, and when it settles on the surface of the coating, its properties are maintained for a long time, and water-repellent and oil-repellent phenomena can be significantly improved by increasing hydrophobicity.

General properties are a density (20° C.) of 1.00 g/mol, a solid content (30 mm, 150° C.) of 25%, solvent Methoxypropylacetate, a flash point of 43° C., and an OH value of 30 mg KOH/g.

The leveling agent B may be included in an amount of 1 to 7 wt % based on 100 wt % of polyaspartic and polyol, which are the main components of polyurethane.

The defoamer is a silicone-containing defoamer modified with fluorine, which reduces bubble generation when applied and quickly bursts bubbles by floating them during vacuum defoaming.

General properties are an active ingredient of 95% or more, a density (20° C.) of 0.80 to 0.82 g/mol, and a flash point of 49° C.

The defoamer may be included in an amount of 0.1 to 1 wt % based on 100 wt % of polyaspartic and polyol, which are the main components of polyurethane, and included in an amount of 0.1 to 1 wt % based on 100 wt % of isocyanate.

According to an embodiment of the present disclosure, the sensor cover is coated with a polyurethane coating composition having the above composition by reaction injection molding.

In other words, the coating composition is prepared by injecting the two liquid raw materials (polyol and isocyanate) into a sealed mold and curing them at high speed within a short time.

Hereinafter, the test results of the coating layer manufactured by the coating composition of an embodiment of the present disclosure are described.

The self-restoration performance of the composition of an embodiment of the present disclosure was tested through the Taguchi test design method.

The test method was to mix main components of the composition and isocyanate (for 3 to 5 minutes), defoam (for 5 to 10 minutes) in a vacuum, inject them into a mold (for 10 minutes), and complete curing at room temperature or 60° C. for 24 hours to produce a sample.

The curing speed was measured by the time for the gel phenomenon, and self-restoration was measured by visually observing self-restoration through a scratch test after complete curing and measuring the time.

The 3-level 4-factor is as shown in Table 1, and Table 2 shows test examples and test results.

TABLE 1

| | | Factor | | | | |
|---|---|---|---|---|---|---|
| | | Poly- | Poly- | | | Mixing ratio |
| | | aspartic | aspartic | | Isocyanate | (resin:isocy- |
| Items | | A | B | Polyol | (type) | anate) |
| Level | A. | 80% | 20% | 0% | A (hard) | 100:50 |
| | B. | 56% | 14% | 30% | B (soft) | 100:100 |
| | C. | 32% | 8% | 60% | A + B | 100:150 |
| | | | | | (50:50) | |

TABLE 2

| | Polyaspartic | Polyaspartic | | | Mixing | | |
|---|---|---|---|---|---|---|---|
| | A | B | Polyol | Isocyanate | ratio | Self- | Self-restoration |
| | (wt %) | (wt %) | (wt %) | (type) | (resin:isocyanate) | restoration | time (seconds) |
| Test | 80 | 20 | 0 | A | 100:50 | NG (hard) | more than 500 |
| example | | | | | | | |
| 1 | | | | | | | |
| Test | 80 | 20 | 30 | B | 100:100 | NG | more than 500 |
| example | | | | | | (curing | |
| 2 | | | | | | impossible) | |
| Test | 80 | 20 | 60 | A + B | 100:150 | OK | 8 |
| example | | | | (50:50) | | | |
| 3 | | | | | | | |
| Test | 56 | 14 | 1 | B | 100:150 | OK | 3 |
| example | | | | | | | |
| 4 | | | | | | | |
| Test | 56 | 14 | 30 | A + B | 100:50 | OK | 10 |
| example | | | | (50:50) | | | |
| 5 | | | | | | | |
| Test | 56 | 14 | 60 | A | 100:100 | NG (hard) | 500 |
| example | | | | | | | |
| 6 | | | | | | | |
| Test | 32 | 8 | 0 | A + B | 100:100 | NG | — |
| example | | | | (50:50) | | | |
| 7 | | | | | | | |
| Test | 32 | 8 | 30 | A | 100:150 | NG (hard) | 500 |
| example | | | | | | | |
| 8 | | | | | | | |
| Test | 32 | 8 | 60 | B | 100:50 | NG | 500 |
| example | | | | | | (curing | |
| 9 | | | | | | impossible) | |

The scratch resistance test is as follows.

After scratching a surface of a test product or a test sample manufactured under equivalent conditions, a surface state was evaluated by the following table according to ISO 1518-1 Erichsen scratch evaluation method.

TABLE 3

| Grade | Exterior |
|---|---|
| 5 | Damage to surface is not recognized. |
| 4 | Damage to surface is slightly recognized. |
| 3 | Damage to surface is slightly recognized but is not |
| | severe. |
| 2 | Damage to surface is recognized |
| 1 | Damage to surface is significantly recognized. |

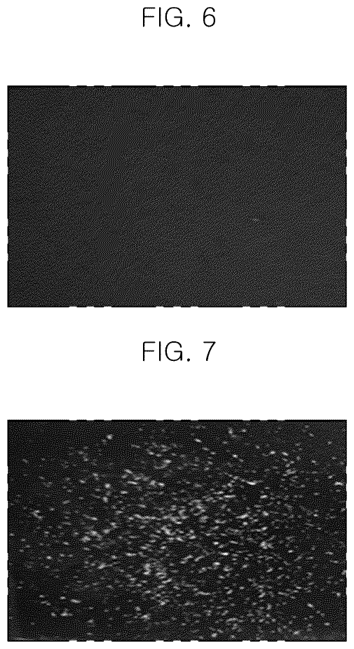

Accordingly, as shown in FIG. 4, the related art was observed as grade 1, and as shown in FIG. 5, an embodiment of the present disclosure was observed as grade 4 or higher (1 minute required).

In this way, it can be seen that the coating composition of an embodiment of the present disclosure has better self-restoration than the conventional coating composition.

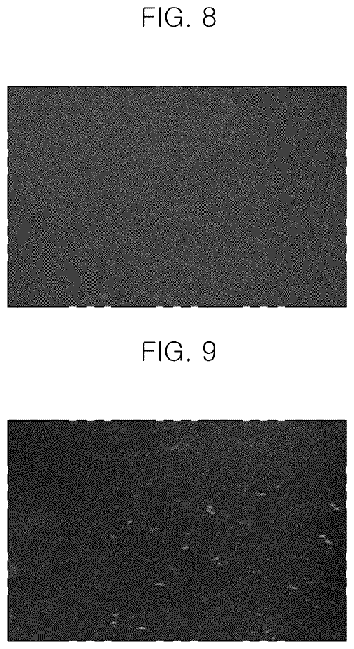

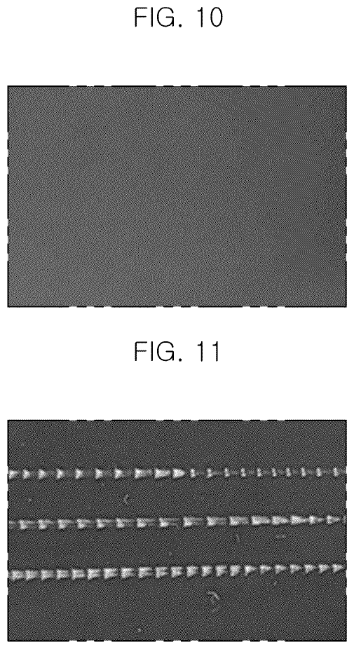

FIG. 6 is a state before a chipping resistance test of a conventional coating layer, and FIG. 7 is a state after the chipping resistance test of the conventional coating layer. In addition, FIG. 8 is a state before a chipping resistance test of a coating layer of an embodiment of the present disclosure, and FIG. 9 is a state after the chipping resistance test of the coating layer of an embodiment of the present disclosure.

The chipping resistance test is as follows.

The chipping resistance test was performed on a test sample cut from a test product using a test stone (GRAVELOMETER: SAE J 400 standard product). However, in the case of a cold test, the test was performed after storing the test sample in a cooler (−40° C.) for at least 3 hours before the test. After the test, dust on a surface of the test sample was removed by Air Blow and an exterior thereof was visually evaluated.

As shown, the results after the test show that the exterior scratch of the present disclosure is superior to that of the conventional one.

After a maximum of 168 hours, the results show that the conventional one has similar self-restoration after the test, but the scratch self-restoration of an embodiment of the present disclosure is similar.

Through this test, it can be seen that the present disclosure has superior self-restoration of the appearance scratch than the conventional one, but the chipping resistance should be superior from the beginning.

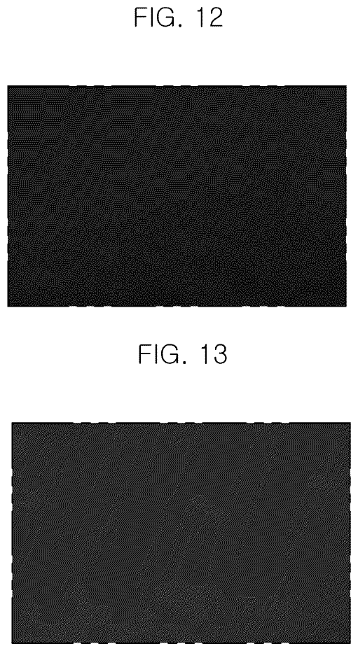

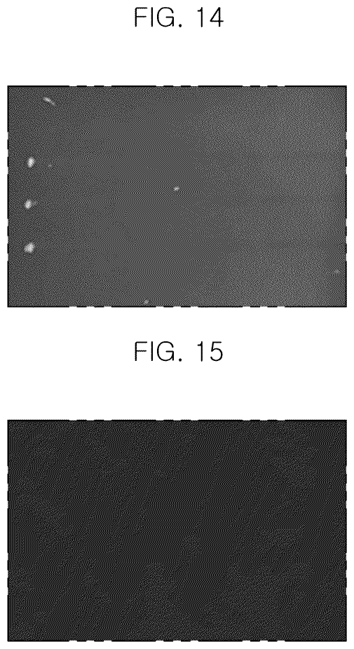

FIG. 10 is a state before a pencil hardness test of the conventional coating layer, and FIGS. 11 and 12 are states after the pencil hardness test of the conventional coating layer. In addition, FIG. 13 is a state before a pencil hardness test of the coating layer of an embodiment of the present disclosure, and FIGS. 14 and 15 are states after the pencil hardness test of the coating layer of an embodiment of the present disclosure.

FIGS. 12 and 14 are observations after the test, and FIGS. 13 and 15 are observations at room temperature (20 to 25° C.) after 24 hours.

In the conventional coating layer, the coating layer was good at pencil hardness B, BH to 6H was NG, and after 24 hours, the coating layer was good.

In the case of an embodiment of the present disclosure, B to 6H was good after the test, and thus checking after 24 hours was unnecessary.

It can be confirmed from the scratch test results that the self-restoration time of the present disclosure is faster than that of the conventional one.

As described above, since the coating composition of the present disclosure has excellent self-restoration performance compared to conventional coating agents and the self-restoration time and curing speed can be adjusted, it is possible to implement a coating agent having desired hardness and self-restoration performance.

Accordingly, when the coating agent is used as a cover for various sensors, particularly, autonomous driving sensors, the coating agent can be helpful in maintaining sensor performance.

Although the present disclosure has been described above with reference to the drawings, the present disclosure is not limited to the described embodiments, and it is apparent to those having ordinary skill in the art that various modifications and changes can be made without departing from the spirit and scope of the present disclosure. Therefore, these modified examples or changed examples should be included in the claims of the present disclosure, and the scope of the present disclosure should be construed based on the appended claims.

What is claimed is:

1. A coating composition for a sensor cover, the coating composition comprising:
a polyaspartic resin; and
an acrylic polyol resin,
wherein the polyaspartic resin and the acrylic polyol resin are mixed in a ratio in a range of 99:1-80:20.

2. The coating composition of claim 1, wherein the polyaspartic resin comprises a first polyaspartic resin and a second polyaspartic resin.

3. The coating composition of claim 2, wherein the first polyaspartic resin and the second polyaspartic resin are mixed in a ratio in a range of 9:1-7:3.

4. The coating composition of claim 2, wherein the first polyaspartic resin includes an amine value (mg KOH/g) in a range of 196-204 and a molecular weight (Mw) in a range of 500-600, and the second polyaspartic resin includes an amine value (mg KOH/g) in a range of 188-196 and a molecular weight (Mw) in a range of 600-700.

5. The coating composition of claim 2, wherein the acrylic polyol resin includes a hydroxyl group (—OH group) in a range of 110-120 and a molecular weight (Mw) in a range of 8,000-10,000.

6. The coating composition of claim 2, wherein an isocyanate curing agent is mixed in an amount in a range of 50-150 wt % based on 100 wt % of the polyaspartic resin.

7. The coating composition of claim 6, wherein the isocyanate curing agent comprises a first isocyanate curing agent and a second isocyanate curing agent.

8. The coating composition of claim 7, wherein the first isocyanate curing agent and the second isocyanate curing agent are mixed in a ratio in a range of 1:9-5:5.

9. The coating composition of claim 7, wherein the first polyaspartic resin and the second polyaspartic resin are mixed in a ratio in a range of 9:1-7:3.

10. The coating composition of claim 9, wherein the first polyaspartic resin includes an amine value (mg KOH/g) in a range of 196-204 and a molecular weight (Mw) in a range of 500-600, and the second polyaspartic resin includes an amine value (mg KOH/g) in a range of 188-196 and a molecular weight (Mw) in a range of 600-700.

11. The coating composition of claim 9, wherein the acrylic polyol resin includes a hydroxyl group (—OH group) in a range of 110-120 and a molecular weight (Mw) in a range of 8,000-10,000.

12. The coating composition of claim 9, wherein an isocyanate curing agent is mixed in an amount in a range of 50-150 wt % based on 100 wt % of the polyaspartic resin.

13. The coating composition of claim 12, wherein the isocyanate curing agent comprises a first isocyanate curing agent and a second isocyanate curing agent, and the first isocyanate curing agent and the second isocyanate curing agent are mixed in a ratio in a range of 1:9-5:5.

14. A sensor cover comprising:
a base layer; and
a protective layer coated on the base layer,
wherein a coating composition forming the protective layer includes:
a first polyaspartic resin and a second polyaspartic resin; and
an acrylic polyol resin,
wherein the first polyaspartic resin and the second polyaspartic resin and the acrylic polyol resin are mixed in a ratio in a range of 99:1-80:20.

15. The sensor cover of claim 14, wherein the first polyaspartic resin and the second polyaspartic resin are mixed in a ratio in a range of 9:1-7:3.

16. The sensor cover of claim 14, wherein the first polyaspartic resin includes an amine value (mg KOH/g) in a range of 196-204 and a molecular weight (Mw) in a range of 500-600, and the second polyaspartic resin includes an amine value (mg KOH/g) in a range of 188-196 and a molecular weight (Mw) in a range of 600-700.

17. The sensor cover of claim 14, wherein the acrylic polyol resin includes a hydroxyl group (—OH group) in a range of 110-120 and a molecular weight (Mw) in a range of 8,000-10,000.

18. The sensor cover of claim 14, wherein an isocyanate curing agent is mixed in an amount in a range of 50-150 wt % based on 100 wt % of the first polyaspartic resin and the second polyaspartic resin.
